(19) United States
(12) Patent Application Publication
(10) Pub. No.: US 2025/0284485 A1
(43) Pub. Date: Sep. 11, 2025

(54) ELECTRONIC CONTROL DEVICE AND STORAGE MEDIUM

(71) Applicant: TOYOTA JIDOSHA KABUSHIKI KAISHA, Toyota-shi (JP)

(72) Inventor: Keiichi FUJIURA, Nisshin-shi (JP)

(73) Assignee: TOYOTA JIDOSHA KABUSHIKI KAISHA, Toyota-shi (JP)

(21) Appl. No.: 18/990,333

(22) Filed: Dec. 20, 2024

(30) Foreign Application Priority Data
Mar. 6, 2024 (JP) 2024-034178

(51) Int. Cl. G06F 8/654; B60R 16/023

(52) U.S. Cl. CPC G06F 8/654; B60R 16/023

(57) ABSTRACT

An electronic control device that executes a parking service by using a specific function of a vehicle during ignition-off of a vehicle, wherein an activation process of writing update target information including a program or data acquired from an external device to a non-volatile memory mounted on the vehicle and enabling the activation process can be received, and when the activation information is received, the execution of the parking service is suppressed.

### CROSS-REFERENCE TO RELATED APPLICATION

This application claims priority to Japanese Patent Application No. 2024-034178 filed on Mar. 6, 2024, incorporated herein by reference in its entirety.

### BACKGROUND

### 1. Technical Field

The present disclosure relates to an electronic control device and a storage medium.

### 2. Description of Related Art

In recent years, the size of programs for vehicle control, diagnostics, etc., installed in an electronic control device (hereinafter also referred to as an “electronic control unit (ECU)”) of a vehicle has been increasing along with the diversification of vehicle control such as a driving support function and an automated driving function. In addition, there is an increasing chance of rewriting (reprogramming) the programs of the ECU along with upgrading of the version of the programs for functional improvements or the like. On the other hand, the technology of connected cars is also spreading along with the development of communication networks and the like. In such a situation, Japanese Unexamined Patent Application Publication No. 2020-27640 (JP 2020-27640 A), for example, proposes a technique in which a vehicle master device as a relay device is provided on the vehicle side. The vehicle master device distributes update data, wirelessly received from a center device, to a rewriting target ECU. Then, the vehicle master device instructs the rewriting target ECU to write the update data, thereby rewriting a program of the rewriting target ECU by Over The Air (OTA).

### SUMMARY

JP 2020-27640 A describes an ECU having a plurality of data storage surfaces as the rewriting target ECU. For example, in a rewriting target ECU having two surfaces, that is, an A surface and a B surface, update data for a new program are written on the B surface. Then, the B surface on which the update data for the new program have been written is switched from a non-operation surface to an operation surface, and the B surface that has been switched from the non-operation surface to the operation surface is started to execute the new program.

JP 2020-27640 A aims at appropriately completing rewriting of a program in a configuration having a plurality of data storage surfaces. In the disclosure described in JP 2020-27640 A, the installation is performed while the vehicle is able to travel or is parked, and the activation is performed while the vehicle is parked. With such a configuration, it is possible to appropriately complete the rewriting of the program in a configuration having a plurality of data storage surfaces.

During parking, there may be a need to execute a during-parking service to be executed on the assumption that the system is driven, in addition to the data rewriting operation by OTA. In the technique described in JP 2020-27640 A, however, there is a case where it is inevitable to refuse to hold a system main relay while the ignition is turned from off to on under a specific condition. For example, when the rewriting target ECU is a battery ECU, a rewriting process is performed by OTA, and surface switching is performed, the system main relay is forcibly shut off, and there is a fear that the system main relay is stuck. In order to resolve the fear that the system main relay is stuck, the battery ECU inevitably refuses to hold the system main relay. When it is attempted to execute a during-parking service in such a situation where the rewriting target ECU inevitably refuses to hold the system main relay, a request to hold the system main relay is not accepted, and there is a fear that a diagnosis code is stored. If it is attempted to resolve the fear that a diagnosis code is stored by not performing a during-parking service unconditionally during execution of data rewriting by OTA, it is not possible to respond to a request to drive the system by the during-parking service at all, impairing convenience.

The present disclosure provides a technique of ensuring convenience of a during-parking service while resolving the fear that a diagnostic code is stored when data rewriting operation by OTA and execution of a during-parking service occur at the same time.

An aspect of the present disclosure provides an electronic control device that executes a during-parking service using a specific function of a vehicle while ignition of the vehicle is turned off, in which:
the electronic control device is able to receive activation information indicating that a different electronic control device is prepared to perform an activation process while refusing to use the specific function, the activation process including writing update target information including a program or data acquired from an external device into a non-volatile memory mounted on the vehicle and activating the update target information; and
execution of the during-parking service is suppressed when the activation information is received.
   The present disclosure is also applied to a storage medium storing a program causing an electronic control device to implement the same function.

According to the present disclosure, it is possible to ensure convenience of a during-parking service while resolving the fear that a diagnostic code is stored when data rewriting operation by OTA and execution of a during-parking service occur at the same time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a configuration of an electronic control system including an electronic control device according to an embodiment;

FIG. 2 is a timing chart for explaining the operation of the electronic control system shown in FIG. 1;

FIG. 3 is a timing chart for explaining the operation of the electronic control system shown in FIG. 1;

FIG. 4 is a timing chart for explaining the operation of the electronic control system shown in FIG. 1;

FIG. 5 is a flowchart for explaining the operation of the electronic control system shown in FIG. 1;

FIG. 6 is a timing chart for explaining the operation of the electronic control system shown in FIG. 1;

FIG. 7 is a timing chart for explaining the operation of the electronic control system shown in FIG. 1;

FIG. 8 is a timing chart for explaining the operation of the electronic control system shown in FIG. 1;

FIG. 9 is a flow chart for describing the operation of the electronic control system shown in FIG. 1; and

FIG. 10 is a block diagram of the electronic control system shown in FIG. 1.

### DETAILED DESCRIPTION OF EMBODIMENTS

Hereinafter, the present embodiment will be described with reference to the accompanying drawings. In order to facilitate understanding of the description, the same components are denoted by the same reference numerals as much as possible in the drawings, and redundant description will be omitted.

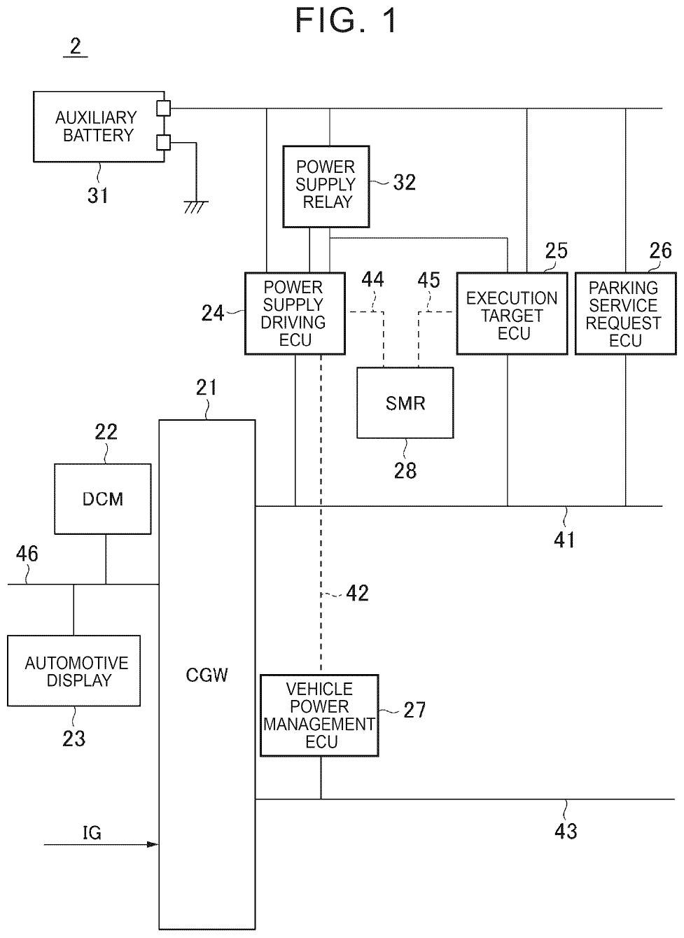

The electronic control system 2 will be described with reference to FIG. 1. The electronic control system 2 is a system mounted on a vehicle. The vehicle on which the electronic control system 2 is mounted is a well-known vehicle equipped with a drive power supply and a drive motor, such as EHV (Electric Hybrid Vehicle), BEV (Battery Electric Vehicle), PHEV (Plug-in Hybrid Electric Vehicle).

The electronic control system 2 is a system that can be rewritten by an OTA (Over The Air) of a program such as vehicle control and diagnostics mounted on an electronic control device (hereinafter, also referred to as an ECU (Electronic Control Unit)). In the present embodiment, a case where the program is rewritten using wireless communication will be described. For example, the present disclosure can be applied to cases where data used in various applications, such as map data used in a map application and control parameters used in an ECU, is rewritten using radio communication.

The rewriting of the program using the wireless communication includes, in addition to the rewriting by acquiring the program from the outside of the vehicle via the wireless communication, the rewriting by acquiring the various data used when the program is executed from the outside of the vehicle via the wireless communication.

As illustrated in FIG. 1, the electronic control system 2 includes a CGW 21, a DCM 22, an in-vehicle display 23, and a power supply driving ECU 24. As illustrated in FIG. 1, the electronic control system 2 includes an execution target ECU 25, a parking service request ECU 26, a vehicle power management ECU 27, an SMR 28, an auxiliary battery 31, a power supply relay 32, buses 41, 43, and 46, and signal-lines 42, 44, and 45.

CGW (Central Gate Way) 21 is a vehicle gateway device. DCM (Data Communication Module) 22 is a vehicle-mounted communication device. DCM 22 and CGW 22 are configured to be capable of data communication via a bus 46.

DCM 22 performs data communication with an external device (not shown) via a communication network. When DCM 22 downloads the update target information including the program or the data from the external device, it forwards the downloaded update target information to CGW 22.

CGW 21 has a data relay function, and when the update target information is acquired from DCM 22, instructs the rewriting target ECU that is the rewrite target to write the acquired update target information, and distributes the update target information to the rewriting target ECU. In addition, when the writing of the update target data is completed and the rewriting is completed in the rewriting target ECU, CGW 21 instructs the rewriting target ECU to activate the program or the like after the rewriting is completed to be valid.

The in-vehicle display 23 is also connected to the bus 46 so as to be capable of data communication. The in-vehicle display 23 has a function of accepting an operation input from a user and a function of displaying various screens, and also serves as a navigation function. The function of the in-vehicle display 23 may be performed by a portable terminal such as a smartphone or a tablet that can be carried by a user. In the vehicle cabin, the user can perform an operation input while confirming various screens involved in rewriting the application program by the in-vehicle display 23, and perform a procedure involved in rewriting the application program.

CGW 21 and DCM 22 constitute a master device in the electronic control system 2 and function as an OTA master. The sharing of functions of CGW 21 and DCM 22 as the master device may be any. A bus 41 and a bus 43 are connected to CGW 21 in addition to the bus 46.

CGW 21 includes a microcomputer (hereinafter referred to as a microcomputer), a data-transfer circuit, a power-supply circuit, and a power-supply detecting circuit as electric functional blocks. The microcomputer includes a CPU (Central Processing Unit), ROM (Read Only Memory), RAM (Random Access Memory), and a flash memory. The flash memory includes a secure area in which data cannot be read from the outside of CGW 21. The microcomputer executes various control programs stored in the non-transitory tangible storage medium, performs various processes, and controls the operation of CGW 21.

The data transferring circuitry controls data communication compliant with the data communication standard and the diagnostic communication standard of CAN (Controller Area Network (registered trademark)) between the buses 41, 43, and 46. The power supply circuit inputs a battery power supply, an accessory power supply, and an ignition power supply. The power supply detection circuit detects the voltage value of the battery power supply input by the power supply circuit, the voltage value of the accessory power supply, and the voltage value of the ignition power supply, compares these detected voltage values with a predetermined voltage threshold, and outputs the comparison result to the microcomputer. The microcomputer determines whether the battery power supply, the accessory power supply, and the ignition power supply supplied from the outside to CGW 21 are normal or abnormal.

DCM 22 includes a microcomputer, a radio circuit, a data transfer circuit, a power supply circuit, and a power supply detecting circuit as electric functional blocks. The microcomputer includes a CPU, a ROM, a RAM, and a flash memory. The flash memory includes a secure area in which data cannot be read from the outside of DCM 22. The microcomputer executes various control programs stored in the non-transitory tangible storage medium, performs various processes, and controls the operation of DCM 22.

The wireless circuit controls data communication via a communication network with an external device. The data transfer circuitry controls data communication with the bus 46 in compliance with CAN data communication standards. The power supply circuit inputs a battery power supply, an accessory power supply, and an ignition power supply. The power supply detection circuit detects the voltage value of the battery power supply input by the power supply circuit, the voltage value of the accessory power supply, and the voltage value of the ignition power supply, compares these detected voltage values with a predetermined voltage threshold, and outputs the comparison result to the accessory power supply, and the ignition power supply supplied from the outside to DCM 22 are normal or abnormal.

A power supply driving ECU 24, an ECU 25 to be executed, and a parking service request ECU 26 are connected to the bus 41 so as to be capable of data communication. A vehicle power management ECU 27 is connected to the bus 43 so as to be capable of data communication.

The power supply driving ECU 24 is an ECU for controlling the drive power supply. For example, if the vehicles are EHV, they are hybrid ECU that provide control to the engine ECU, the motor ECU, and the battery ECU.

The execution target ECU 25 in the explanation of the present embodiment is an OTA program/data rewriting target ECU that is an OTA reprogramming execution target ECU. In the explanation of the present embodiment, a battery ECU will be described.

The parking service request ECU 26 is an ECU for executing the in-parking service. The parking service is a service for holding and executing the system main relay during the ignition off of the vehicle. In the present embodiment, it is assumed that the parking service request ECU 26 is not an OTA master, nor is it ECU to execute OTA.

The vehicle power management ECU 27 is an ECU that manages the entire vehicle power supply. When a special power ON request is transmitted from the parking service request ECU 26, for example, the vehicle power management ECU 27 outputs a special power ON to the power supply driving ECU 24. In the following description and the description in the drawings, the flags relating to the special power supply and the special power supply are also referred to as “IGB”. The vehicle power management ECU 27 transmits a special power supply ON signal to the power supply driving ECU 24 using a signal line 42 which is a direct line. Upon receiving the special power supply ON signal, the power supply driving ECU 24 turns ON the power supply relay 32. The power supply relay 32 is a relay that is driven by a power supply driving ECU 24 and ON-OFF drives the power supply of another ECU. When the power supply relay 32 is turned ON, power is supplied from the auxiliary battery 31, and ECU 25 to be executed is activated.

ECU 25 to be executed, which is the power supply driving ECU 24 and the battery ECU, outputs an SMR holding request to SMR (System Main Relay) 28. The power supply driving ECU 24 transmits SMR holding-request signal using, for example, the signal line 44. ECU 25 to be executed transmits SMR holding-request signal using, for example, the signal line 45.

SMR 28 is a system main relay. An SMR 28, which is a system main relay, is provided between a driving battery (not shown) and a power control unit (not shown), and switches between a conduction state and a non-conduction state between the driving battery and the power control unit. SMR 28 is turned on when SMR hold request signal is received, and is turned off when SMR hold request signal is not received.

The above-described ECU includes, as electric functional blocks, a microcomputer, a data-transfer circuit, a power supply circuit, and a power supply detecting circuit. The microcomputer includes a CPU, a ROM, a RAM, and a flash memory. The flash memory includes a secure area in which data cannot be read from the outside of ECU. The microcomputer executes various control programs stored in the non-transitory tangible storage medium, performs various processes, and controls the operation of ECU.

The above-described ECU includes a microcomputer having a so-called ROM two surfaces. For example, the microcomputer has a first data storage surface and a second data storage surface in which at least one of the program and the parameter data is stored. On this premise, the microcomputer operates at least one of the program and the data stored in the first data storage surface, which is the operation surface (the old surface), in the traveling state or the parking state of the vehicle. At the same time, the microcomputer executes a process of writing at least one of the update program or the update data acquired from the external device to the second data storage surface which is the non-operation surface. The microcomputer executes an activation process of switching the operation surface from the first data storage surface to the second data storage surface in a parking state of the vehicle.

The data transferring circuitry controls data communication with the buses 41 and 43 in conformity with the data communication standard of CAN. The power supply circuit inputs a battery power supply, an accessory power supply, and an ignition power supply. The power supply detection circuit detects the voltage value of the battery power supply input by the power supply circuit, the voltage value of the accessory power supply, and the voltage value of the ignition power supply, compares these detected voltage values with a predetermined voltage threshold, and outputs the comparison result to the accessory power supply, and the ignition power supply supplied from the outside to ECU are normal or abnormal. It should be noted that the ECUs have basically the same configuration, but they are different in loads such as the sensors, actuators, and the like connected thereto.

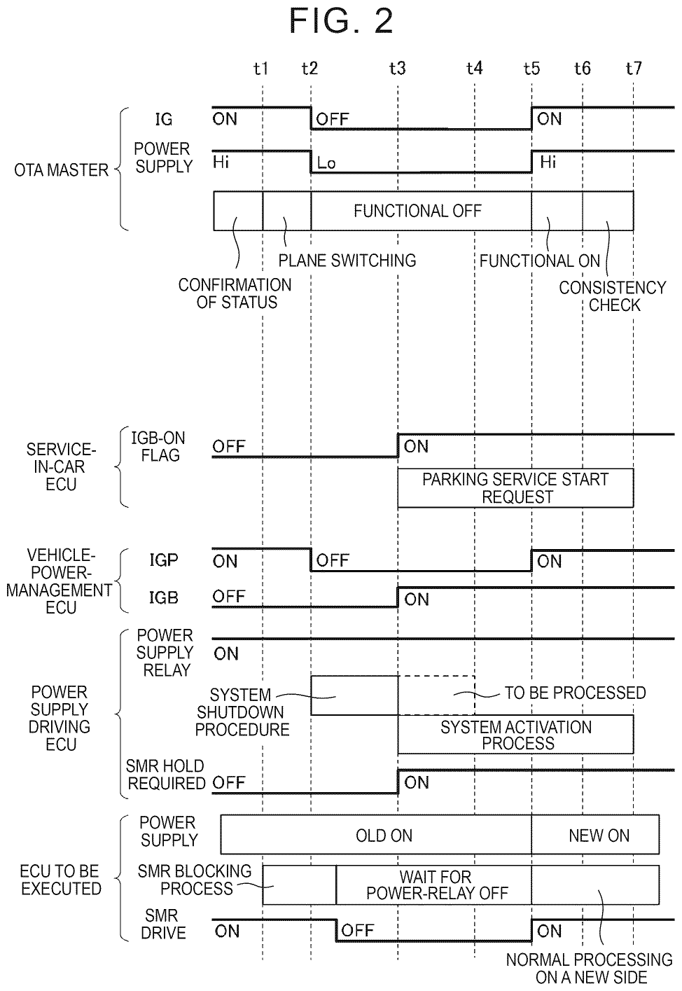

Next, the operation of the electronic control system 2 will be described. First, the operation of the electronic control system 2 when processing specific to the present embodiment is not performed will be described with reference to FIG. 2. The timing chart shown in FIG. 2 shows the operation of OTA master (CGW 21 and DCM 22), the parking service request ECU 26, the vehicle power management ECU 27, the power supply driving ECU 24, and ECU 25 to be executed, along the respective time axes.

In the initial state of FIG. 2, the ignition is in ON state. By the time t1, OTA master performs status checking, etc. The status check includes checking a status such as whether writing of a program or data received by OTA is completed. In the time t1, when the program or data received by OTA has been written, an activation approval request from the user is displayed on the in-vehicle display 23. In the present embodiment, it is assumed that the activation is approved by the user in the time t1.

Between the time t1 and the time t2, OTA master issues a face switching setup request. In the time t2, the ignition is switched OFF by the user. When the user ignition is turned OFF, the power of OTA master is switched from Hi to Lo.

In the time t5, the ignition is switched ON by the user. When the user ignition is turned ON, the power of OTA master is switched from Lo to Hi. Since the power is Lo from the time t2 to the time t5, OTA master stops functioning. The power is turned Hi in the time t5, so OTA master starts up. The time t6 completes the activation of OTA master. In the time t6, the user confirms activation (Teady-ON) via the in-vehicle display 23. From the time t6 to the time t7, OTA master performs version-consistent checking of programs and data.

The parking service request ECU 26 sets a flag (IGB-ON) for turning ON the special power supply in the time t3, and requests the initiation of the in-parking service.

The vehicle power management ECU 27 switches ON-OFF of the direct line signal and CAN signal of the ignition by the user in accordance with the ignition manipulation by the user. In the following description and the description in the drawings, flags related to ignition by the user and ignition by the user are also referred to as “IGP”. The vehicle power management ECU 27 switches ON-OFF of the direct line signal and CAN signal of the special power supply (IGB) in accordance with the special power supply flag (IGB-ON) of the parking service request ECU 26. Therefore, in the time t3, the special power supply (IGB) is turned ON.

The power supply driving ECU 24 executes a system-ending process from the time t2 at which the ignition (IGP) is OFF by the user. In the present embodiment, it is assumed that the system-ending process is to be executed until the time t4 if there is no other demand.

When the parking service request ECU 26 makes a time t3 with a flag that turns ON the special power supply (IGB-ON) and requests that the in-parking service be started, the special power supply (IGB) is turned ON. In the time t3, the power supply driving ECU 24 is in the system termination process, but since the special power supply (IGB) is turned ON, the system termination process is rounded up and the process shifts to the system startup process. At the time t3 of the transition to the system-startup process, the power supply driving ECU 24 outputs a hold-request to SMR 28.

The power supply driving ECU 24 turns ON the power supply relay 32 until the system-termination process is completed. In FIG. 2, since the system start-up process is performed while the system end process is not completed, the power supply relay 32 is not turned OFF and remains ON.

ECU 25 to be executed, which is a battery ECU, executes the power ON process on the old side of the microcomputer. The execution target ECU 25 is switched to execution on the new side of the microcomputer at the time of ignition (IGP) ON by the user. ECU 25 to be executed has an essential function even in the parking service by the parking service request ECU 26, such as an SMR 28 holding process.

The execution target ECU 25 performs a process of shutting off SMR 28, which is a control for inhibiting ECU sleep, in the system-ending process of the power supply driving ECU 24. In the present embodiment, SMR 28 shut-off process is completed between the time t2 and the time t3, and the power supply relay 32 is waiting for OFF. The execution target ECU 25 rejects SMR 28 holding request. OFF is to drive SMR 28 at this timing.

As described above, the parking service request ECU 26 issues an SMR 28 holding request at the time t3. On the other hand, since the execution target ECU 25 rejects the request to hold SMR 28, there is a fear that the both requests are inconsistent and the dialog is stored.

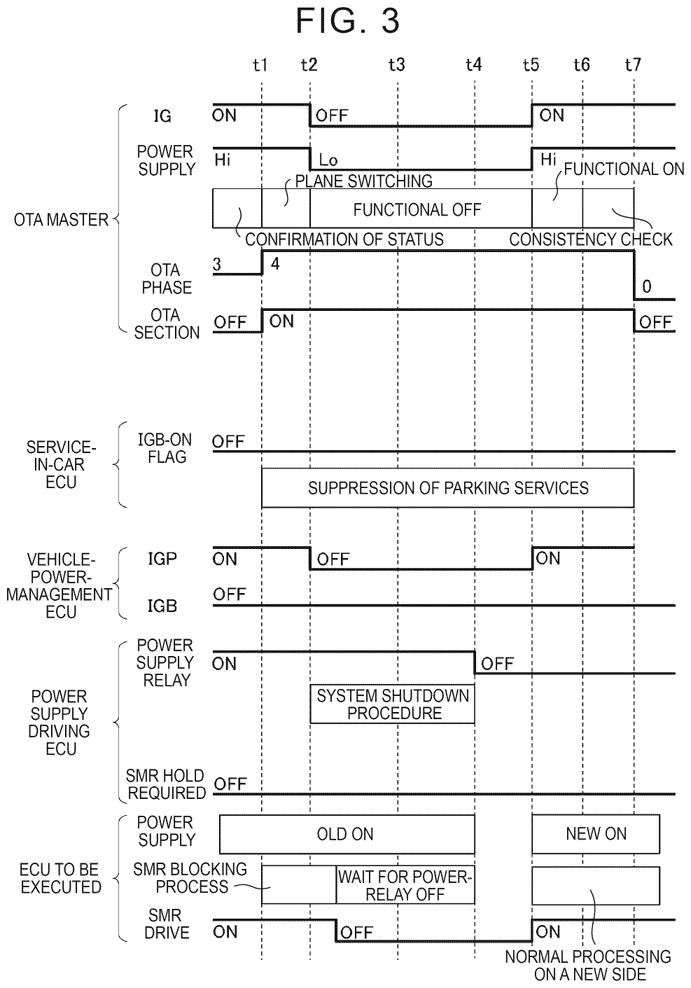

Next, with reference to FIG. 3, a description will be given of an example of a process for solving the above-described concern of dialog storage. The timing chart shown in FIG. 3 also shows the operation of OTA master (CGW 21 and DCM 22), the parking service request ECU 26, the vehicle power management ECU 27, the power supply driving ECU 24, and the execution target ECU 25 along the respective time axes. Since the operations as the premise are the same as those described in FIG. 2, the differences will be mainly described.

OTA master outputs OTA phase information and OTA activation period information. OTA phase information is information indicating the status of OTA process. For example, “3” indicates that a program or data is being installed in OTA phase. For example, “4” indicates that OTA phase information is being activated and version-consistent check is being performed. OTA phase data indicates, for example, that “0” is waiting. OTA activation period information is information indicating that OTA process is being activated and the version-consistency check is being performed.

In the embodiment illustrated in FIG. 3, OTA phase information is switched from “3” to “4” at the time t1, and OTA activation period information is switched from OFF to ON. In the time t7, OTA phase information is switched from “4” to “0”, and OTA activation period information is switched from ON to OFF.

OTA phase information and OTA activation section information are configured to be received by the parking service request ECU 26. Therefore, the parking service request ECU 26 can recognize that OTA process is being performed from the time t1 to the time t7. Therefore, in the present embodiment, the parking service request ECU 26 does not request the in-parking service in this section. Therefore, unlike the case described referring to FIG. 2, the flag for turning ON the special power supply (IGB) is not set in the time t3, and the starting of the parking service is not requested. The parking service request ECU 26 can determine which phase OTA is in based on OTA phase information and OTA activation section information, but cannot obtain information on which ECU is OTA target.

Since the in-park servicing is suppressed, the vehicle power management ECU 27 does not turn ON the special power supply (IGB). As shown in FIG. 2, the system-termination process by the power supply driving ECU 24 is continued until the time t4, which is the initial scheduled time, is completed without being interrupted.

Since the system-termination process is completed at the time t4, the power supply driving ECU 24 turns OFF the power supply relay 32. Since the execution target ECU 25 is waiting for the power supply relay 32 to turn OFF, the power supply is turned OFF at the time t4.

SMR 28 blocking process is completed between the time t2 and the time t3, and the execution target ECU 25 rejects SMR 28 holding request. Since the in-parking service is suppressed, the discrepancy as described with reference to FIG. 2 does not occur, and the concern of the dialog memory is eliminated.

In the time t7, since OTA phase information is switched from “4” to “0” and OTA activation section information is switched from ON to OFF, the suppression of the in-parking servicing is released at this timing.

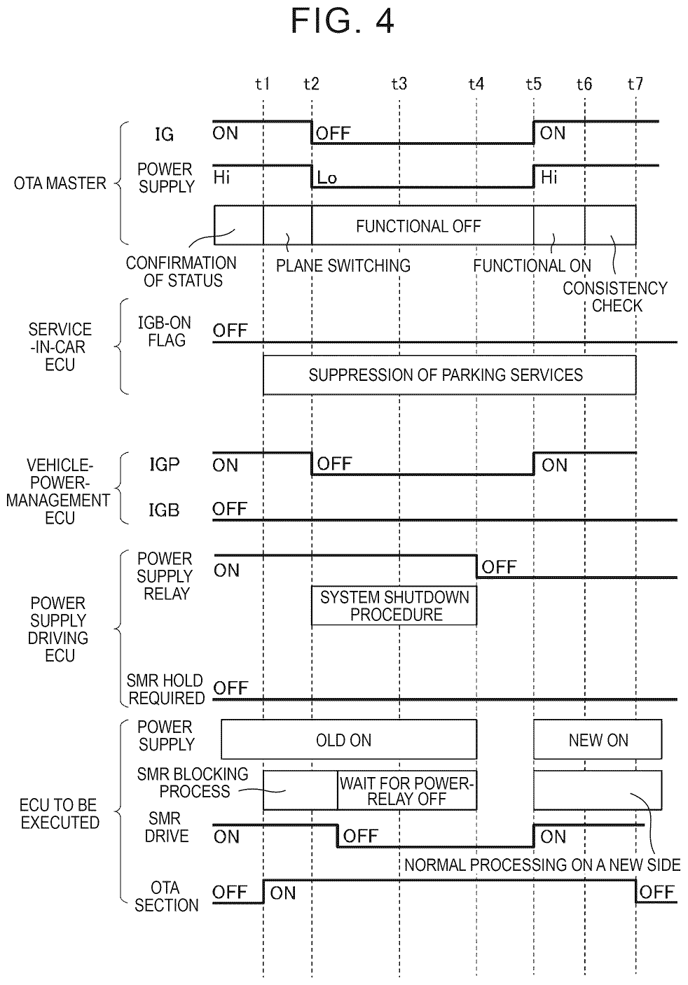

Next, with reference to FIG. 4, a description will be given of an example of a process for solving the above-described concern of dialog storage. The timing chart shown in FIG. 4 also shows the operation of OTA master (CGW 21 and DCM 22), the parking service request ECU 26, the vehicle power management ECU 27, the power supply driving ECU 24, and the execution target ECU 25 along the respective time axes. Since the operations as the premise are the same as those described in FIGS. 2 and 3, the different points will be mainly described.

In the explanation referring to FIG. 3, OTA master outputs OTA phase information and OTA activation period information. Since OTA activation section information can also be output from the execution target ECU 25, an exemplary case where the execution target ECU 25 outputs OTA activation section information will be described referring to FIG. 4.

In the embodiment illustrated in FIG. 4, OTA activation period data is switched from OFF to ON in the time t1. In the time t7, OTA activation period data is switched from ON to OFF.

The execution target ECU 25 outputs OTA activation section data, and the parking service request ECU 26 is set to receive the data. Therefore, the parking service request ECU 26 can recognize that OTA process is being performed from the time t1 to the time t7. As described with reference to FIG. 3, in this section, the parking service request ECU 26 does not request the parking service.

Similar to the description with reference to FIG. 3, a discrepancy as described with reference to FIG. 2 does not occur, and the concern of dialog storage is eliminated. Further, at time t7, OTA activation section data is switched from ON to OFF, so that the suppression of the in-parking-service is released at this timing.

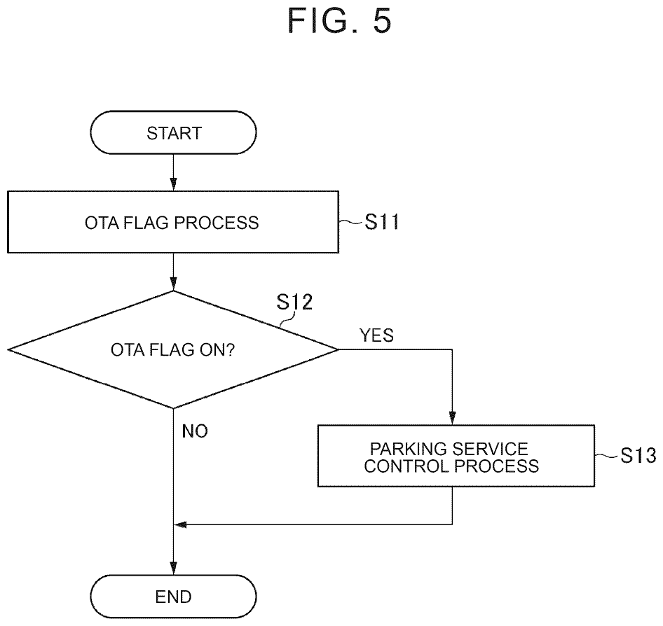

Next, the operation of the electronic control system 2 will be described with reference to the flowchart shown in FIG. 5. In S11, OTA flag process is executed. OTA flag process is a process executed by OTA master or ECU 25 to be executed, and is a process of switching OTA activation section data to ON or OFF and transmitting it to the parking service request ECU 26.

In S12 following S11, it is determined whether OTA activation section data, which is OTA flag, is turned ON by the parking service request ECU 26. If OTA activation period is ON (S12: YES), the processing proceeds to S13. If OTA activation period information is not ON (S12: NO), the parking service request ECU 26 terminates the determination of OTA activation period information and continues the normal control.

In S13, the parking service request ECU 26 executes the in-parking service suppressing process. As described with reference to FIGS. 3 and 4, the parking service suppression process is continued until a predetermined condition is satisfied.

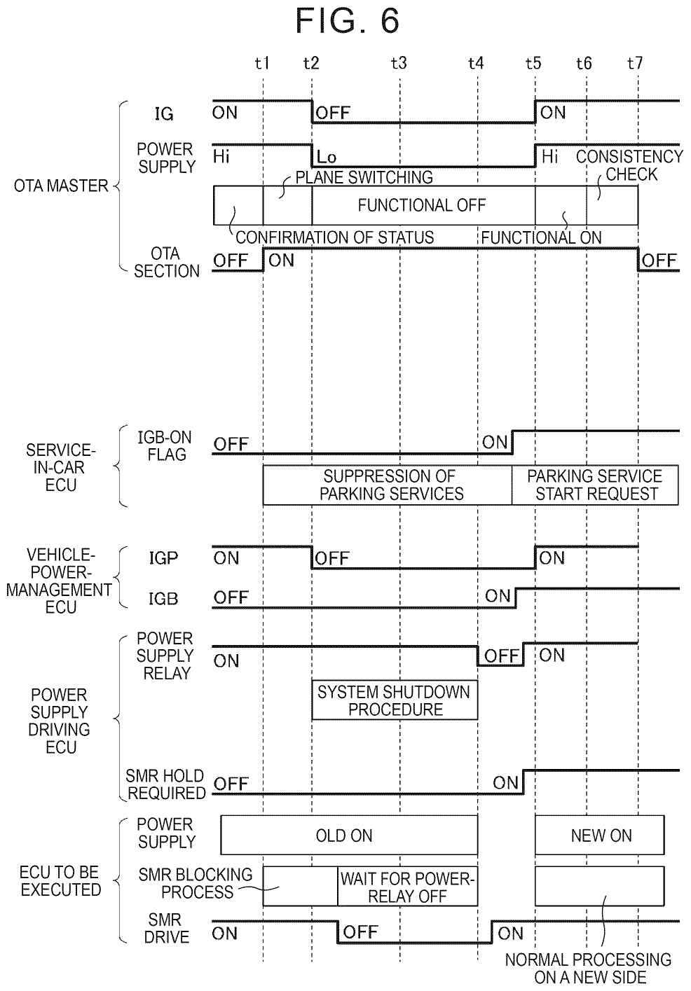

Next, with reference to FIG. 6, a description will be given of an example of a process for solving the above-described concern of dialog storage. In the explanation referring to FIGS. 3 and 4, while OTA activation section data is ON, the in-park servicing is suppressed. Even if the in-parking service is suppressed in this way, the in-parking service is resumed after the user confirms the version consistency after the re-ignition ON. Therefore, there is an advantage that it is easy to understand that the control is performed after updating the program or the data. On the other hand, OTA activation section data is ON until after the ignition (IGP) by the user is turned ON, during which time parking servicing is suppressed. In FIG. 6, a process for further enhancing convenience will be described.

The timing chart shown in FIG. 6 also shows the operation of OTA master (CGW 21 and DCM 22), the parking service request ECU 26, the vehicle power management ECU 27, the power supply driving ECU 24, and the execution target ECU 25 along the respective time axes. Since the operations as the premise are the same as those described in FIG. 2, the differences will be mainly described.

OTA master outputs OTA activation period information. OTA activation period information is information indicating that OTA process is being activated and the version-consistency check is being performed.

In the embodiment illustrated in FIG. 6, OTA activation period data is switched from OFF to ON at the time t1, and is switched from ON to OFF at the time t7.

OTA activation period is configured to be received by the parking service request ECU 26. Therefore, the parking service request ECU 26 can recognize that OTA process is being performed from the time t1 to the time t7.

The concerns of the dialog described with respect to FIG. 2 are caused by the continuation of the rejection of SMR 28 holding request by ECU 25 to be executed. The execution target ECU 25 performs a process of shutting off SMR 28, which is a control for inhibiting ECU sleep, in the system-ending process of the power supply driving ECU 24. In the present embodiment, SMR 28 shut-off process is completed between the time t2 and the time t3, and the power supply relay 32 is waiting for OFF.

Therefore, after the power supply relay 32 is turned OFF, the power supply of the execution target ECU 25 is also turned OFF, so that it is unnecessary to continue the rejection of SMR 28 holding request by the execution target ECU 25.

Therefore, in the embodiment illustrated in FIG. 6, the period from when OTA activation section data is turned ON until after the completion of the system-end process by the power supply driving ECU 24 is set as the in-parking service-suppression period. In the embodiment illustrated in FIG. 6, the parking service request ECU 26 is set to be the in-parking service suppressing period for a predetermined period of time from the time t1 at which OTA activation section information is turned ON to the time after the system-ending process is completed by the power supply driving ECU 24. The predetermined time is a time until the system-termination process is expected to be completed by the power supply driving ECU 24, and is set between the time t4 and the time t5 in FIG. 6.

The parking service request ECU 26 enters the in-parking service start request period at a timing at which the in-parking service suppression period ends. The parking service request ECU 26 sets a flag (IGB-ON) to turn ON the special power supply between the time t4 and the time t5, and requests the initiation of the in-parking service.

The vehicle power management ECU 27 switches ON-OFF of the direct line signal and CAN signal of the special power supply (IGB) in accordance with the special power supply flag (IGB-ON) of the parking service request ECU 26. Therefore, the special power supply (IGB) is turned ON between the time t4 and the time t5.

The power supply driving ECU 24 executes a system-ending process from the time t2 at which the ignition (IGP) OFF by the user to the time t4. The power supply driving ECU 24 turns ON the power supply relay 32 until the time t4 at which the system-termination process is completed. Since the system-termination process is completed at the time t4, the power supply relay 32 is turned OFF at the time t4.

The execution target ECU 25 performs a process of shutting off SMR 28, which is a control for inhibiting ECU sleep, in the system-ending process of the power supply driving ECU 24. In the present embodiment, SMR 28 shut-off process is completed between the time t2 and the time t3, and the power supply relay 32 is waiting for OFF. The execution target ECU 25 rejects SMR 28 holding request. OFF is to drive SMR 28 at this timing.

Since the power supply relay 32 is turned OFF at the time t4, ECU 25 to be executed releases OFF waiting status of the power supply relay 32. The execution target ECU 25 is released from the state of rejecting SMR 28 holding request after the completion of the system-ending process by the power supply driving ECU 24.

The execution target ECU 25 is in a state where the interruption process of SMR 28 is completed between the time t2 and the time t3 and SMR 28 holding request is rejected, but the rejection state is released after the time t4. Therefore, the request for the in-parking service is made by the parking service request ECU 26, and even if SMR 28 holding request is generated, there is no discrepancy, and there is no fear of the diagnosis memory.

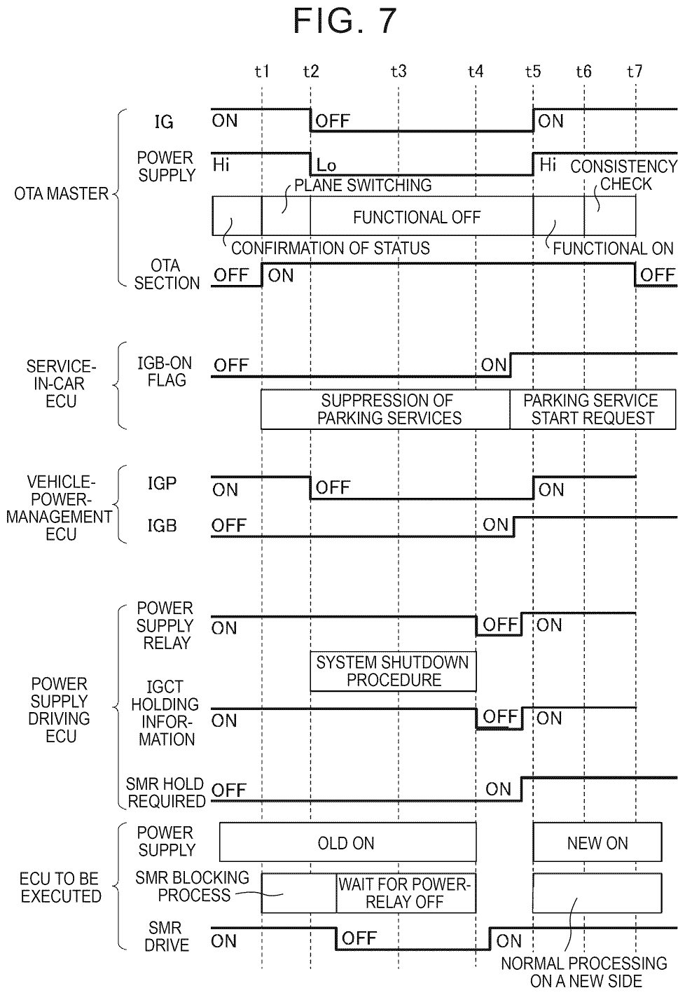

Next, with reference to FIG. 7, a description will be given of an example of a process for solving the above-described concern of dialog storage. The description with reference to FIG. 7 corresponds to another example described with reference to FIG. 6.

The timing chart shown in FIG. 7 also shows the operation of OTA master (CGW 21 and DCM 22), the parking service request ECU 26, the vehicle power management ECU 27, the power supply driving ECU 24, and the execution target ECU 25 along the respective time axes. Since the operations as the premise are the same as those described in FIGS. 2 and 6, the different points will be mainly described.

In the embodiment illustrated in FIG. 7, the power supply driving ECU 24 outputs the holding data of the power supply relay 32. The holding information of the power supply relay 32 is information that is ON when the power supply relay 32 is in ON state and is turned OFF when it is in OFF state. The holding information of the power supply relay 32 is transmitted to the parking service request ECU 26.

At the time t4, the power supply driving ECU 24 completes the system-ending process, and the power supply relay 32 is turned OFF. At this timing, the holding data of the power supply relay 32 is turned OFF, and the parking service request ECU 26 cancels the suppression of the parking service.

In the time t4, the status of rejecting SMR 28 holding request by the execution target ECU 25 is canceled in the same manner as described while referring to FIG. 6. Therefore, the request for the in-parking service is made by the parking service request ECU 26, and even if SMR 28 holding request is generated, there is no discrepancy, and there is no fear of the diagnosis memory.

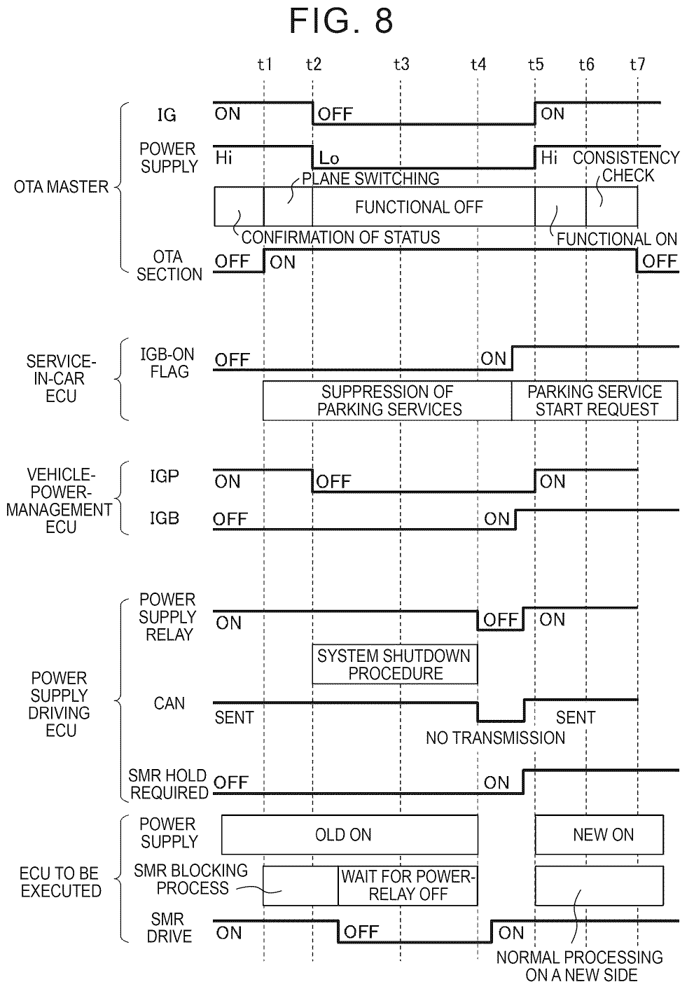

Next, with reference to FIG. 8, a description will be given of an example of a process for solving the above-described concern of dialog storage. The description with reference to FIG. 8 corresponds to another example described with reference to FIG. 6.

The timing chart shown in FIG. 8 also shows the operation of OTA master (CGW 21 and DCM 22), the parking service request ECU 26, the vehicle power management ECU 27, the power supply driving ECU 24, and the execution target ECU 25 along the respective time axes. Since the operations as the premise are the same as those described in FIGS. 2 and 6, the different points will be mainly described.

In the embodiment illustrated in FIG. 8, the power supply driving ECU 24 is outputting CAN. CAN data is data in which transmission is continued when the power supply relay 32 is in ON state and transmission is stopped when the power supply relay is in OFF state. CNA is transmitted to the parking service request ECU 26. CNA may not be relevant to OTA process, but is a frame with a relatively short transmit period.

At the time t4, the power supply driving ECU 24 completes the system-ending process, and the power supply relay 32 is turned OFF. At this timing, CAN transmission is stopped, and the parking service request ECU 26 cancels the suppression of the in-parking service.

In the time t4, the status of rejecting SMR 28 holding request by the execution target ECU 25 is canceled in the same manner as described while referring to FIG. 6. Therefore, the request for the in-parking service is made by the parking service request ECU 26, and even if SMR 28 holding request is generated, there is no discrepancy, and there is no fear of the diagnosis memory.

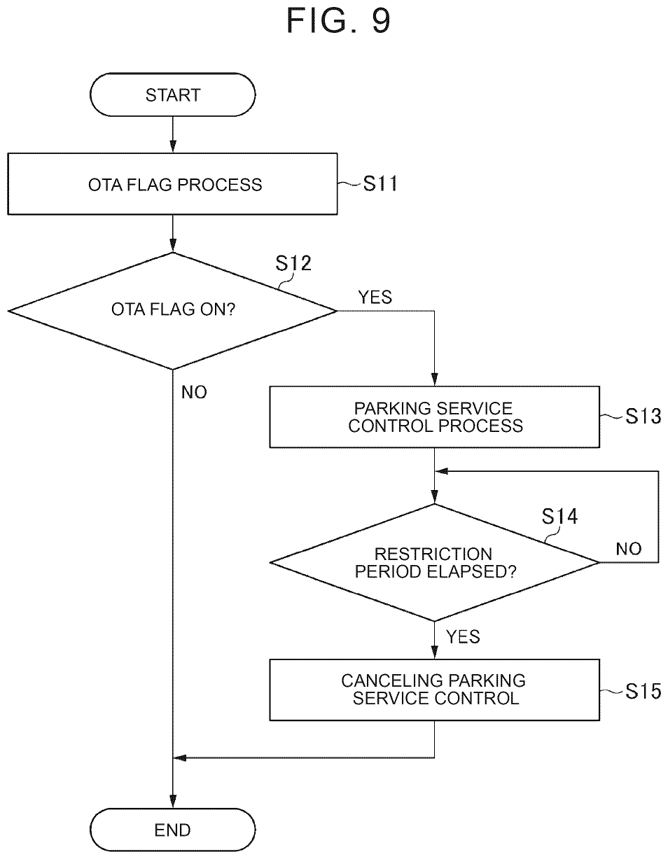

Next, the operation of the electronic control system 2 described with reference to FIGS. 6, 7, and 8 will be described with reference to the flowchart shown in FIG. 9. In S11, OTA flag process is executed. OTA flag process is a process executed by OTA master or ECU 25 to be executed, and is a process of switching OTA activation section data to ON or OFF and transmitting it to the parking service request ECU 26.

In S12 following S11, it is determined whether OTA activation section data, which is OTA flag, is turned ON by the parking service request ECU 26. If OTA activation period is ON (S12: YES), the processing proceeds to S13. If OTA activation period information is not ON (S12: NO), the parking service request ECU 26 terminates the determination of OTA activation period information and continues the normal control.

In S13, the parking service request ECU 26 executes the in-parking service suppressing process.

In S14 following S13, it is determined by the parking service request ECU 26 whether the in-parking service is suppressed. As described with reference to FIGS. 6, 7, and 8, the elapse of the suppression period of the parking service is determined based on the elapse of a predetermined time and the information transmitted to the power supply driving ECU 24.

If the suppression time of the in-park service has elapsed (S14: YES), the process proceeds to S15. If the suppression time of the in-park service has not elapsed (S14: NO), the process continues S14.

In S15, the parking service request ECU 26 cancels the suppression duration of the in-parking service and performs normal control.

The electronic control system described herein (a component such as an ECU, CGW, DCM including a microcomputer that executes control) and its technique may be implemented by a dedicated computer provided by configuring a processor and a memory programmed to perform one or more functions embodied by a computer program. Alternatively, the electronic control system (a component such as an ECU, CGW, DCM including a microcomputer that executes control) and the technique described in the present disclosure may be realized by a dedicated computer provided by configuring a processor by one or a plurality of dedicated hardware logic circuits. Alternatively, an electronic control system (a component such as an ECU, CGW, DCM including a microcomputer that executes control) and a method thereof described in the present disclosure may be realized by one or more dedicated computers configured by a processor programmed to execute one or more functions and a processor configured by a memory and one or more hardware logic circuits. In addition, the computer program may be stored in a non-transitory computer-readable tangible recording medium (storage medium) as an instruction executed by a computer.

The present embodiment has been described above with reference to specific examples. However, the present disclosure is not limited to these specific examples. Those skilled in the art with appropriate design modifications to these specific examples are also included in the scope of the present disclosure as long as they include the features of the present disclosure. Each element included in each of the above-described specific examples and the arrangement, condition, shape, and the like thereof are not limited to those illustrated, and can be appropriately changed. Each element included in each of the above-described specific examples can be appropriately combined and changed as long as there is no technical inconsistency.

### Appendices

The following Appendices 1 to 7 can be arbitrarily combined as long as they are not technically contradictory.

### Appendix 1

An electronic control device for performing a parking service using a specific function of a vehicle during ignition-off of a vehicle, comprising: It is possible to receive the activation information indicating that the processing preparation of the other electronic control device which performs the activation processing of writing and activating the update target information including the program or the data acquired from the external device to the nonvolatile memory mounted on the vehicle with the use refusal of the specific function is completed.

When the activation information is received, execution of the parking service is suppressed.

As the electronic control device of Appendix 1, the above-described embodiment exemplifies a parking service request ECU 26. The electronic control device of Appendix 1 is not limited to the parking service request ECU 26, but can be implemented as an ECU involved in executing a parking service that is executed using a particular function of the vehicle during ignition-off of the vehicle. As a specific function of the vehicle, the system main relay is exemplified in the above-described embodiment, but any function may be used as the parking service performed during the ignition-off of the vehicle. ECU that performs the activation process is an electronic control device different from the electronic control device of Appendix 1. As an ECU of performing the activation process, in the above-described embodiment, ECU 25 to be executed is exemplified and specifically described as a battery ECU. ECU for performing the activation process is not limited to this, and can be applied to an ECU where there is a mode in which the use of a particular function, such as a system main relay, is rejected after the activation process is prepared.

According to Appendix 1, activation information indicating that the preparation for the activation process is completed is received, and the execution of the parking service is suppressed during the ignition-off of the vehicle. For this reason, it is possible to eliminate a discrepancy between the process of ECU that may reject the holding request of the system main relay when the activation process is completed and the ignition-off condition of the vehicle is satisfied, and it is possible to eliminate the fear of the dialog memory when the data rewriting operation by OTA and the execution of the parking service coexist.

### Appendix 2

The electronic control device according to Appendix 1, wherein the execution suppression of the in-parking service is canceled after the denial of use of the specific function by another electronic control device that performs the activation process is canceled.

According to Appendix 2, since the execution suppression of the in-parking service is canceled after the denial of use of the specific function by the other electronic control device is canceled, the execution suppression of the in-parking service is not permanently suppressed, and the in-parking service can be executed while eliminating the concern of the dialog memory.

### Appendix 3

The activation information includes that the activation process is being executed and that the activation process is completed.

The electronic control device according to Appendix 2, wherein, after the activation information transitions from the execution of the activation process to the completion indication, the execution suppression of the parking service is canceled.

According to Appendix 3, since the execution suppression of the parking service is canceled after the activation process is completed, the execution suppression of the parking service is not permanently suppressed, and the parking service can be executed while eliminating the concern of the dialog memory.

### Appendix 4

The electronic control device according to Appendix 2, wherein, after receiving the activation information and recognizing that the preparation for the activation process is completed, the execution suppression of the in-parking service is released after a predetermined time has elapsed from the ignition off of the vehicle.

According to Appendix 4, since the execution suppression of the in-parking service is canceled after a predetermined time has elapsed from the ignition off of the vehicle, the in-parking service can be executed while eliminating the concern of the dialog memory at a more accurate timing.

### Appendix 5

The electronic control device according to Appendix 2, wherein, after receiving the activation information and recognizing that the preparation for the activation process is completed, the execution suppression of the in-parking service is released after the drive power holding state of the vehicle is released.

According to Appendix 5, the execution suppression of the parking service is released after the drive power holding state of the vehicle is released. Therefore, an ECU that may reject the holding request of the system main relay in association with the driving power holding state of the vehicle is released from the rejection mode, and the execution suppression of the in-parking service is canceled, so that the in-parking service can be executed at an early stage while eliminating the concern of the dialog memory.

### Appendix 6

The electronic control device according to Appendix 4, wherein when the reception of the signal indicating the driving power holding state of the vehicle is interrupted, it is recognized that the driving power holding state of the vehicle is released.

According to Appendix 6, since the reception state of the signal indicating the driving power holding state of the vehicle recognizes that the driving power holding state of the vehicle has been released, it is possible to execute the parking service at a more accurate timing.

### Appendix 7

In the electronic control device,
during the ignition off of a vehicle, a parking service is executed using a specific function of the vehicle.
   An activation process for writing and activating update target information including a program or data acquired from an external device to a non-volatile memory mounted on a vehicle is performed by receiving activation information indicating that a process preparation of another electronic control device is completed, which is performed with the use of a specific function being rejected.
   A program that suppresses execution of a parking service when activation information is received.

According to Appendix 7, it is possible to provide a program that achieves the same operation and effect as Appendix 1. Appendices 2 to 6 can also be implemented as programs in the same manner as the appendix 7.

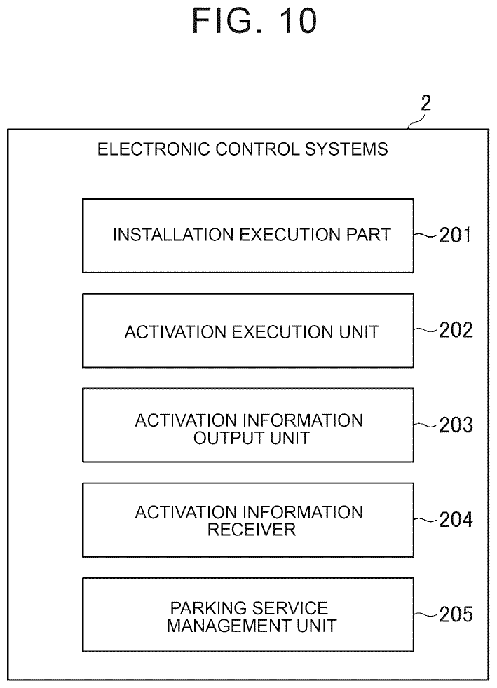

The electronic control devices described in Appendices 1 to 6 are included in the electronic control system 2. The electronic control system 2 is an assembly of ECU including a flash memory as a non-volatile memory having a first data storage surface and a second data storage surface in which at least one of a program and data is stored. As illustrated in FIG. 10, the electronic control system 2 includes, as functional components, an installation execution unit 201, an activation execution unit 202, an activation information output unit 203, an activation information reception unit 204, and a parking service management unit 205.

The installation execution unit 201 operates at least one of programs and data stored in the first data storage surface, which is an operation surface, in a traveling state or a parking state of the vehicle on which the electronic control system 2 is mounted. At the same time, the installation execution unit 201 writes at least one of the update program or the update data acquired from the external device to the second data storage surface which is the non-operation surface.

The activation execution unit 202 switches the operation surface from the first data storage surface to the second data storage surface in the parking state of the vehicle.

The activation information output unit 203 outputs activation information indicating that the installation execution unit 201 or the activation execution unit 202 is executing. In the above embodiment, the activation information is described as OTA phase information or OTA activation section information. The activation information includes information indicating that the program or the update target information including the data acquired from the external device is written in the non-volatile memory mounted on the vehicle, and the preparation for the activation process for enabling the written area is completed. The activation information includes information indicating that the activation process is being executed and that the activation process is completed.

The activation information output unit 203 may be provided in CGW 21 and DCM 22 as OTA master, as described while referring to FIGS. 1 to 3 and 6 to 8. The activation information output unit 203 may be provided in ECU 25 to be executed, as described with reference to FIG. 4.

The activation information reception unit 204 receives the activation information output from the activation information output unit 203. When receiving the activation information, the parking service management unit 205 suppresses execution of the in-parking service using the driving power of the vehicle. In the above embodiment, it is assumed that the activation information reception unit 204 and the parking service management unit 205 are provided in the parking service request ECU 26.

What is claimed is:

1. An electronic control device that executes a during-parking service using a specific function of a vehicle while ignition of the vehicle is turned off, wherein:
the electronic control device is able to receive activation information indicating that a different electronic control device is prepared to perform an activation process while refusing to use the specific function, the activation process including writing update target information including a program or data acquired from an external device into a non-volatile memory mounted on the vehicle and activating the update target information; and
execution of the during-parking service is suppressed when the activation information is received.

2. The electronic control device according to claim 1, wherein suppression of the execution of the during-parking service is canceled after refusal to use the specific function by the different electronic control device is canceled.

3. The electronic control device according to claim 2, wherein:
the activation information includes information indicating that the activation process is being executed and information indicating that the activation process has been completed; and
the suppression of the execution of the during-parking service is canceled after the activation information transitions from the information indicating that the activation process is being executed to the information indicating that the activation process has been completed.

4. The electronic control device according to claim 2, wherein the suppression of the execution of the during-parking service is canceled after receiving the activation information and recognizing that preparation for the activation process has been completed and after a predetermined time has elapsed since the ignition of the vehicle is turned off.

5. The electronic control device according to claim 2, wherein the suppression of the execution of the during-parking service is canceled after receiving the activation information and recognizing that preparation for the activation process has been completed and after a state in which a drive power supply for the vehicle is held is canceled.

6. The electronic control device according to claim 5, wherein it is recognized that the state in which the drive power supply for the vehicle is held is canceled when reception of a signal indicating that the state in which the drive power supply for the vehicle is held is interrupted.

7. A non-transitory storage medium storing a program causing an electronic control device to perform a process comprising:
executing a during-parking service using a specific function of a vehicle while ignition of the vehicle is turned off;
receiving activation information indicating that a different electronic control device is prepared to perform an activation process while refusing to use the specific function, the activation process including writing update target information including a program or data acquired from an external device into a non-volatile memory mounted on the vehicle and activating the update target information; and
suppressing execution of the during-parking service when the activation information is received.
